(19) United States
(12) Patent Application Publication
(10) Pub. No.: US 2024/0328919 A1
(43) Pub. Date: Oct. 3, 2024

(54) ENVIRONMENT MEASUREMENT DEVICE

(71) Applicant: SINTOKOGIO, LTD., Nagoya-shi (JP)

(72) Inventors: Keisuke TAKAYANAGI, Nagoya-shi (JP); Atsushi HATA, Nagoya-shi (JP); Takashi SUZUKI, Nagoya-shi (JP)

(73) Assignee: SINTOKOGIO, LTD., Nagoya-shi (JP)

(21) Appl. No.: 18/604,916

(22) Filed: Mar. 14, 2024

(30) Foreign Application Priority Data
Mar. 28, 2023 (JP) 2023-051179

(51) Int. Cl. G01N 15/075; G01N 15/00

(52) U.S. Cl. CPC G01N 15/075; G01N 2015/0046

(57) ABSTRACT

The environment measurement device includes: a housing having a first intake port, a second intake port, and an exhaust port, a dust sensor defining a first flow path and configured to detect dust contained in the air passing through the first flow path, the dust sensor being disposed inside the housing such that an inlet of the first flow path is connected to the first intake port, a fan disposed on the exhaust port such that a discharge of the fan is directed toward the exhaust port, a dust filter provided in the second intake port and configured to collect dust contained in the air supplied from the second intake port, and an environmental sensor configured to measure air supplied from the second intake port through the dust filter, wherein the air supplied from the first intake port and the second intake port are exhausted from the exhaust port.

### CROSS-REFERENCE TO RELATED APPLICATIONS

This application claims the benefit of priority from Japanese Patent Application No. 2023-051179, filed on Mar. 28, 2023, the entire contents of which are incorporated herein by reference.

### TECHNICAL FIELD

The present disclosure relates to an environment measurement device.

### BACKGROUND

Japanese Unexamined Patent Application Publication No. H08-320394 discloses a portable optical dust sensor. The dust sensor sucks air by a fan, irradiates light to the sucked air, and measures an amount of change in intensity of light transmitted through the air by a measuring device. The amount of change in intensity of light depends on an increase or a decrease in dust in air.

### SUMMARY

The dust sensor described in Japanese Unexamined Patent Application Publication No. H08-320394 can measure the amount of dust in air, however, cannot measure other environment values in air. Therefore, in consideration of portability, a dust sensor and an environmental sensor that measures another environment value in air may be accommodated in a single housing. However, since the dust sensor takes air including dust into the housing, dust may be attached to the environmental sensor, and performance of the environmental sensor may be deteriorated. Therefore, it is conceivable that a room for dust sensor and a room for environmental sensor are partitioned in the housing and fans are provided in the respective rooms. However, since the number of components is increased, there is a possibility that miniaturization of the device is hindered. The present disclosure provides a device capable of measuring not only the amount of dust in the air but also other environment values in the air, while avoiding inhibition of miniaturization of the device.

An environment measurement device according to one aspect of the present disclosure includes: a housing with a hollow interior having a first intake port, a second intake port, and an exhaust port; a dust sensor defining a first flow path through which air passes and configured to detect dust contained in the air passing through the first flow path, the dust sensor being disposed inside the housing such that an inlet of the first flow path is connected to the first intake port; a fan configured to generate an air flow inside the housing, the fan being spaced apart from the dust sensor and disposed on the exhaust port inside the housing such that a discharge of the fan is directed toward the exhaust port; a dust filter provided in the second intake port and configured to collect dust contained in the air supplied from the second intake port; and an environmental sensor configured to measure air supplied from the second intake port through the dust filter, wherein the air supplied from the first intake port and the second intake port are exhausted from the exhaust port.

According to the present disclosure, it is possible to measure not only the amount of dust in air but also other environment values in air while avoiding inhibition of miniaturization of a device.

### BRIEF DESCRIPTION OF THE DRAWINGS

FIG. 1 is a perspective view of an environment measurement device according to an embodiment.

FIG. 2 is a schematic cross-sectional view of the environment measurement device according to the embodiment.

FIG. 3 is a diagram illustrating an air flow of an environment measurement device according to an embodiment.

FIG. 4 is a schematic cross-sectional view of an environment measurement device according to a modification.

### DETAILED DESCRIPTION

Hereinafter, embodiments of the present disclosure will be described in detail with reference to the drawings. In the description of the drawings, the same elements are denoted by the same reference numerals, and redundant description is omitted. The dimensional ratios in the drawings are not necessarily consistent with those in the description. The terms “up”, “down”, “left” and “right” are based on the illustrated state and are for convenience.

### [Outline of Environment Measurement Device]

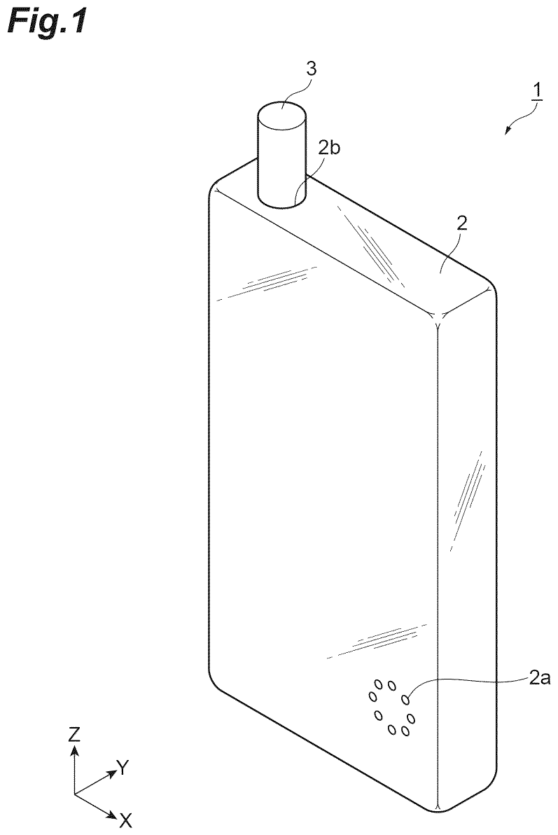

FIG. 1 is a perspective view of an environment measurement device according to an embodiment. An environment measurement device 1 shown in FIG. 1 is, for example, a portable measuring device. The environment measurement device 1 can measure the amount of dust in the air. In addition, the environment measurement device 1 can measure various environment values. The environment measurement device 1 is carried by a worker to measure, for example, the environment of a factory.

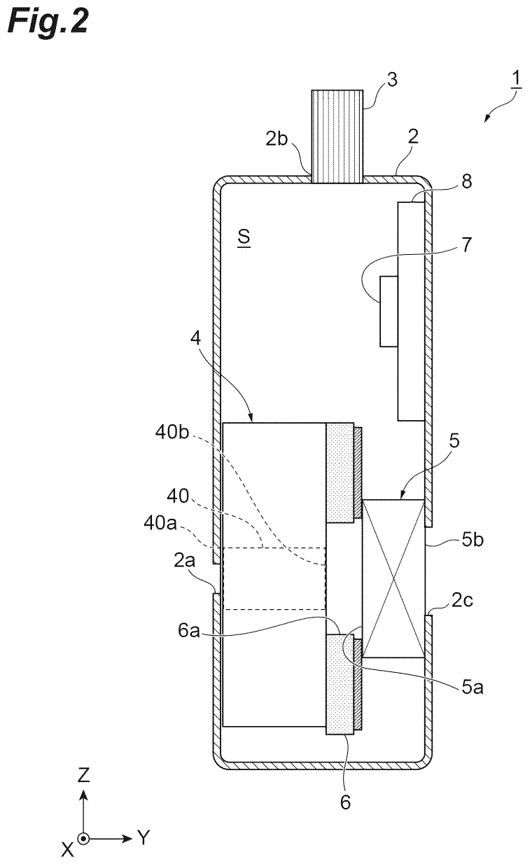

FIG. 2 is a schematic cross-sectional view of the environment measurement device according to the embodiment. As shown in FIGS. 1 and 2, the environment measurement device 1 includes a housing 2. The housing 2 is a generally rectangular parallelepiped member that is hollow and defines a space S therein. The shape of the housing 2 is not limited to a rectangular parallelepiped, and may be a cylinder or the like.

The housing 2 has a first intake port 2a, a second intake port 2b and an exhaust port 2c. The first intake port 2a and the second intake port 2b are introduction ports that communicate with the inside of the housing 2 and introduce air of the housing 2 external into the inside of the housing 2. The first intake port 2a and the second intake port 2b are formed, for example, at positions separated from each other. As an example, the first intake port 2a is formed on a side surface of the housing 2, and the second intake port 2b is formed on an upper surface of the housing 2.

A dust filter 3 is provided in the second intake port 2b. The dust filter 3 has a function of collecting dust contained in air. The air supplied into the housing 2 from the second intake port 2b becomes air from which dust is removed by the dust filter 3. By way of example, the dust filter 3 is made of porous material such as sponge. The dust filter 3 may be composed of fibrous filler material such as nonwoven fabric. The dust filter 3 may be a removable cylindrical filter. In this case, since the filtration area of the dust filter 3 can be larger than that of a filter having another shape, the frequency of filter replacement can be reduced.

The exhaust port 2c communicates with the inside of the housing 2 and is an outlet for discharging the air of the housing 2 to the outside. As an example, the exhaust port 2c is formed on a side surface facing the side surface on which the first intake port 2a is formed. As described later, air supplied into the housing 2 through the first intake port 2a and the second intake port 2b is discharged from the exhaust port 2c.

The environment measurement device 1 includes a dust sensor 4 inside the housing 2. The dust sensor 4 is a sensor that detects dust in the air. The dust sensor 4 is a sensor that measures the amount of dust in the air, and is an optical dust sensor as an example. The dust sensor 4 defines a first path 40 therein for air to pass through. The dust sensor 4 measures the amount of dust by irradiating air passing through the first path 40 with light and measuring the intensity of the light transmitted through the air.

The dust sensor 4 is disposed inside the housing 2 such that an inlet 40a of the first path 40 is connected to the first intake port 2a. For example, the dust sensor 4 is fixed to a side wall of the housing 2 in which a first intake port 2a is formed inside the housing 2. Since the first intake port 2a and the first flow path 40 communicate with each other, the air supplied from the first intake port 2a is directly introduced into the first flow path 40 of the dust sensor 4. Note that the shape and number of first intake ports 2a are not particularly limited as long as air can be supplied to the dust sensor 4. For example, as shown in FIG. 1, the first intake port 2a may be formed of a plurality of through-holes.

The environment measurement device 1 includes a fan 5 for supplying air to the interior of the housing 2 and for evacuating the supplied air. The fan 5 is a device that generates air flow by rotating blades, and has a suction port 5a and a discharge port 5b. The fan 5 is arranged to be spaced apart from the dust sensor 4. That is, a gap is provided between the dust sensor 4 and the fan 5. The fan 5 is then disposed on the exhaust port 2c inside the housing 2 such that the fan 5 discharge is directed to the exhaust port 2c. For example, the fan 5 is fixed to the side wall of the housing 2 in which the exhaust port 2c is formed inside the housing 2. This connects the discharge port 5b to the exhaust port 2c.

Air inside the housing 2 is exhausted from the exhaust port 2c by the operation of the fan 5, and the inside of the housing 2 becomes negative pressure. When the inside of the housing 2 becomes negative pressure, air is supplied into the housing 2 from the first intake port 2a and the second intake port 2b. In this manner, the fan 5 operates to generate first air flow that sends air in the first flow path 40 of the dust sensor 4 to the exhaust port 2c. By generating the first air flow, the dust sensor 4 can measure dust, and air after being measured by the dust sensor 4 is immediately exhausted. Therefore, the dust is prevented from diffusing inside the housing 2 or adhering to the inside of the housing 2.

The environment measurement device 1 further includes an environmental sensor 7 that measures air supplied from the second intake port 2b through the dust filter 3. The environmental sensor 7 is a sensor for measuring air. The environmental sensor 7, like the dust sensor 4, is a sensor where air flow is required for measurement. The environmental sensor 7 may be, for example, a gas sensor, a temperature sensor, or a humidity sensor. The environment measurement device 1 may further includes an illuminance sensor, a sound sensor, a vibration sensor, or the like as the environmental sensor 7. The environmental sensor 7 is arranged at a position separated from the dust sensor 4 and the fan 5 when viewed from a direction in which the dust sensor 4 and the fan 5 face each other. The environmental sensor 7 is provided on a substrate 8 and outputs a detection signal or the like to a control circuit (not shown) provided on the substrate 8. The control circuit is constituted by a PLC or the like, and is communicably connected to components such as the dust sensor 4, the fan 5, and the environmental sensor 7.

When the inside of the housing 2 becomes negative pressure due to the operation of the fan 5, not only first air flow but also second air flow from the intake port 2b to the exhaust port 2c is generated. Due to the generation of the second air flow, the air from which dust has been removed reaches the environmental sensor 7, and the environmental sensor 7 can measure the air. For example, the environmental sensor 7 measures the composition of the gas in air. The air after being measured by the environmental sensor 7 is exhausted from the exhaust port 2c through the gap between the dust sensor 4 and the fan 5.

The environment measurement device 1 may further include a partition member 6 to further avoid the dust from diffusing inside the housing 2. For example, since the first air flow is not generated immediately after the operation of the fan 5 is stopped, the air including dust is retained in the first flow path 40. In addition, air including dust also stays in the clearance between the dust sensor 4 and the fan 5. The partition member 6 is provided between the dust sensor 4 and the fan 5 in order to prevent dust contained in such stagnant air from diffusing.

The partition member 6 defines a second flow path 6a through which air that has passed through the dust sensor 4 flows. The partition member 6 connects an outlet 40b of the first flow path 40 of the dust sensor 4 and the suction port 5a of the fan 5. The partition member 6 is secured to the dust sensor 4 and the fan 5 by, for example, an adhesive. In the partition member 6, at least a part of a member for defining a second flow path 6a is constituted of a filter for passing air. This allows the partition member 6 to have air permeability and allow air after being measured by the environmental sensor 7 to pass through the gap between the dust sensor 4 and the fan 5 and be exhausted from the exhaust port 2c. The partition member 6 may consist entirely of a filter. The filter of the partition member 6 is made of a porous member such as sponge, and has a pore size such that dust cannot pass through. Therefore, dust contained in air retained in the first flow path 40 and in the clearance between the dust sensor 4 and the fan 5 is prevented from diffusing into the housing 2. The partition member 6 filter may be formed of fibrous filler material such as a nonwoven fabric.

The partition member 6 is not particularly limited in shape and thickness as long as it defines the second flow path 6a and connects the outlet 40b of the first flow path 40 and the suction port 5a of the fan 5. The partition member 6 filter may be less dense than the dust filter 3.

### [Operation of Environment Measurement Device]

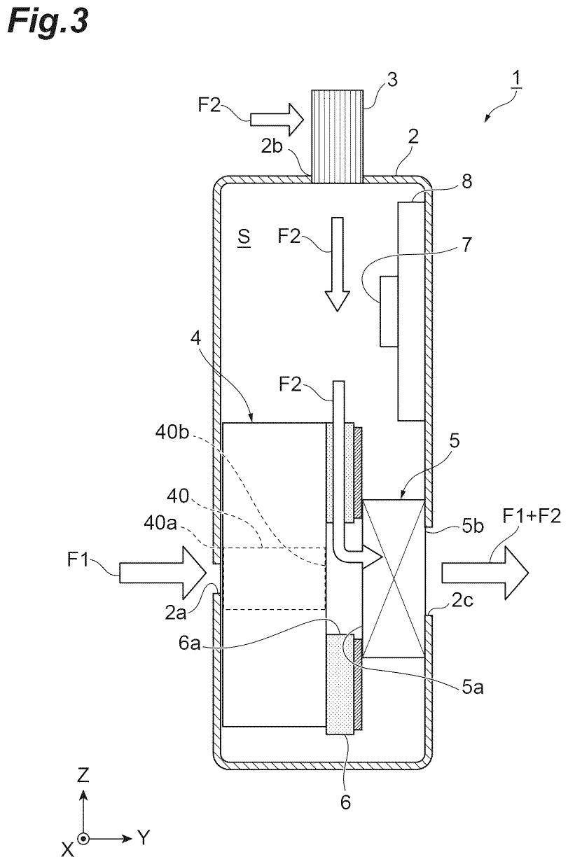

FIG. 3 is a diagram illustrating an air flow of an environment measurement device according to an embodiment. When the environment measurement device 1 is activated, the substrate 8 is energized and the dust sensor 4, the fan 5 and the environmental sensor 7 are activated. When the fan 5 is turned on, the inside of the housing 2 becomes negative pressure. As indicated by first air flow F1 in the figure, the air supplied from the first intake port 2a passes through the first flow path 40 of the dust sensor 4, and the amount of dust is measured during the path. The air that has passed through the dust sensor 4 passes through the second flow path 6a of the partition member 6, passes through the fan 5, and is exhausted from the exhaust port 2c.

When the fan 5 is turned on, air supplied from the second intake port 2b further generates second air flow F2 that supplies air to the environmental sensor 7. As indicated by second air flow F2 in the figure, air supplied from the second intake port 2b does not contain dust and reaches the environmental sensor 7. Then, gas components in the air are measured. The air that has passed through the environmental sensor 7 reaches the second flow path 6a from the outside of the partition member 6, passes through the fan 5, and is exhausted from the exhaust port 2c.

### SUMMARY OF EMBODIMENT

In the environment measurement device 1, a negative pressure is created inside the housing 2 by the fan 5 disposed on the exhaust port 2c. Thus, the air of the housing 2 external is supplied into the housing 2 from the first intake port 2a and the second intake port 2b. Air supplied from the first intake port 2a passes through the first flow path 40 of the dust sensor 4, and dust in the air is measured. The air that has passed through the first flow path 40 is exhausted from the exhaust port 2c by the first air flow F1. Thus, the dust in the air is measured, and the dust is prevented from diffusing or adhering to the inside of the housing 2. Dust contained in air supplied from the second intake port 2b is collected by the dust filter 3. As a result, it is avoided that dust is diffused or attached inside the housing 2 by air supplied from the second intake port 2b. In the air from which dust has been removed, gas components and the like are measured by the environmental sensor 7, and the air is exhausted from the exhaust port 2c. As described above, since the intake port is prepared for each sensor, dust can be collected in the second intake port 2b that supplies air for which dust is not a measurement target. Since the exhaust port is shared between the sensors, the environment measurement device 1 can eliminate the need for an additional fan. Therefore, the environment measurement device 1 can measure the environment value other than the dust in the air without hindering weight reduction and miniaturization while preventing the dust from being accumulated inside the housing of the device.

### Modification

While various exemplary embodiments have been described above, various omissions, substitutions and changes may be made without being limited to the exemplary embodiments described above.

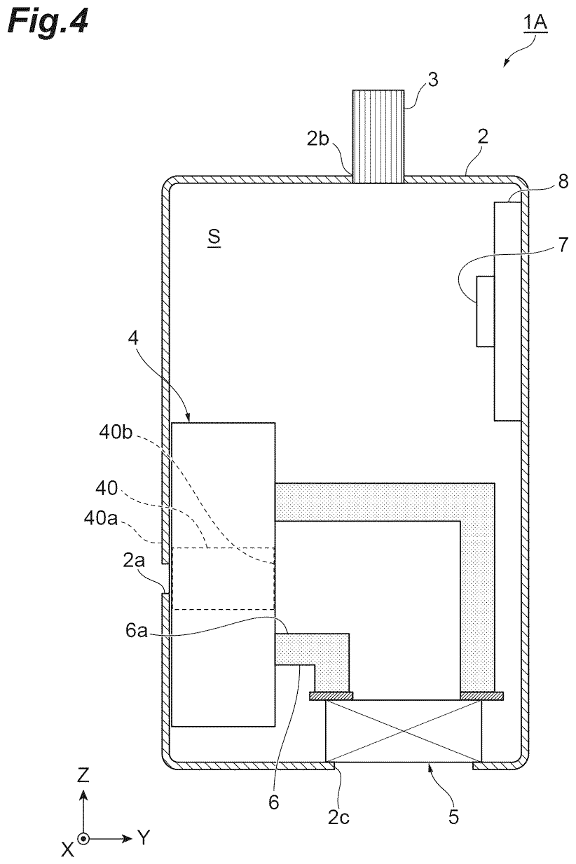

For example, the environment measurement device 1 may not include the partition member 6. Further, positions of the intake port and the exhaust port are not limited to those in the embodiment. FIG. 4 is a schematic cross-sectional view of an environment measurement device according to a modification. An environment measurement device 1A shown in FIG. 4 differs from the environment measurement device 1 in the position of the exhaust port 2c and the shape of the partition member 6, and is otherwise identical. As shown in FIG. 4, the exhaust port 2c is formed at the bottom of the housing 2, and the first intake port 2a and the exhaust port 2c are not facing each other. Even in such a case, by connecting the outlet 40b of the first flow path 40 in which the partition member 6 is the dust sensor 4 and the suction port 5a of the fan 5, the environment measurement device 1A can exhibit the same effect as that of the environment measurement device 1.

### Embodiments Included in the Present Disclosure

The present disclosure includes the embodiments described in the following clauses.

### Clause 1

An environment measurement device according to one aspect of the present disclosure includes: a housing with a hollow interior having a first intake port, a second intake port, and an exhaust port; a dust sensor defining a first flow path through which air passes and configured to detect dust contained in the air passing through the first flow path, the dust sensor being disposed inside the housing such that an inlet of the first flow path is connected to the first intake port; a fan configured to generate an air flow inside the housing, the fan being spaced apart from the dust sensor and disposed on the exhaust port inside the housing such that a discharge of the fan is directed toward the exhaust port; a dust filter provided in the second intake port and configured to collect dust contained in the air supplied from the second intake port; and an environmental sensor configured to measure air supplied from the second intake port through the dust filter, wherein the air supplied from the first intake port and the second intake port are exhausted from the exhaust port.

In the environment measurement device according to clause 1, a fan disposed in the exhaust port creates a negative pressure inside the housing. As a result, of the device external is supplied into the housing from the first intake port and the second intake port. The air supplied from the first intake port passes through the first flow path of the dust sensor, and the dust in the air is measured. The air that has passed through the first flow path is discharged from the exhaust port the by first air flow. Thus, the dust in the air is measured, and the dust is prevented from diffusing or adhering to the inside of the housing. Dust contained in air supplied from a second intake port is collected by a dust filter. As a result, it is avoided that dust is diffused or attached inside the housing by air supplied from the second intake port. The dust-removed air is measured by an environmental sensor and exhausted from the exhaust port. In this manner, since the intake port is prepared for each sensor, dust can be collected in the second intake port that supplies air for which dust is not a measurement target. Since the exhaust port is shared between the sensors, the environment measurement device may not need an additional fan. Therefore, the environment measurement device can measure other environment values in air without hindering weight reduction and size reduction while avoiding dust accumulation inside the housing of the device. Further, since an additional fan is not required, the cost of the device can be reduced.

### Clause 2

The environment measurement device according to clause 1 may further include a partition member defining a second flow path through which air passing through the dust sensor flows and connecting an outlet of the first flow path of the dust sensor and the fan, wherein at least a portion of the partition member is configured as a filter through which air passes. Since the partition member connects the first flow path of the dust sensor and the fan, it is possible to prevent dust remaining in the first flow path from diffusing into the housing when the fan is stopped. Air supplied from the second intake port passes through the filter of the partition member and is exhausted from the exhaust port. Since the environment measurement device includes a partition member that allows air to pass therethrough, it is possible to achieve both prevention of dust diffusion and commonality of fans.

### Clause 3

In the environment measurement device according to clause 1 or 2, the environmental sensor may include a gas sensor. In this case, the environment measurement device can measure not only dust in air but also gas in air.

### Clause 4

In the environment measurement device according to any one of clauses 1 to 3, the dust sensor and the fan may be disposed to face each other. In this case, the environment measurement device can efficiently generate the first air flow from first flow path of the dust sensor toward the exhaust port. In addition, since the dust sensor and the fan are disposed to face each other, the environment measurement device may be compact.

What is claimed is:

1. An environment measurement device comprising:
a housing with a hollow interior having a first intake port, a second intake port, and an exhaust port;
a dust sensor defining a first flow path through which air passes and configured to detect dust contained in the air passing through the first flow path, the dust sensor being disposed inside the housing such that an inlet of the first flow path is connected to the first intake port;
a fan configured to generate an air flow inside the housing, the fan being spaced apart from the dust sensor and disposed on the exhaust port inside the housing such that a discharge of the fan is directed toward the exhaust port;
a dust filter provided in the second intake port and configured to collect dust contained in the air supplied from the second intake port; and
an environmental sensor configured to measure air supplied from the second intake port through the dust filter,
wherein the air supplied from the first intake port and the second intake port are exhausted from the exhaust port.

2. The environment measurement device according to claim 1, further comprising a partition member defining a second flow path through which air passing through the dust sensor flows and connecting an outlet of the first flow path of the dust sensor and the fan, wherein at least a portion of the partition member is configured as a filter through which air passes.

3. The environment measurement device according to claim 1, wherein the environmental sensor comprises a gas sensor.

4. The environment measurement device according to claim 1, wherein the dust sensor and the fan are disposed to face each other.
